(19) United States
(12) Patent Application Publication
(10) Pub. No.: US 2004/0188272 A1
(43) Pub. Date: Sep. 30, 2004

(54) Method for reducing degradation of reactive compounds during transport

(76) Inventors: Jeremy Daniel Blanks, Middletown, DE (US); Velliyur Nott Mallikarjuna Rao, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/396,795

(22) Filed: Mar. 25, 2003

(51) Int. Cl. B23H 3/00

(52) U.S. Cl. 205/640

(57) ABSTRACT

The present invention relates to a method for reducing the degradation of reactive compounds during transport of such reactive compounds from one location to another location by electropolishing the surface that the reactive compound contacts during transport, minimizing the internal surface area to volume ratio or the transport equipment, and minimizing or eliminating the dead volume in the transport equipment to reduce the degradation of the product during transport.

### BACKGROUND OF THE INVENTION

1. Field of the Invention

The present invention relates to a method for handling of reactive chemical compounds by the chemical industry and in industrial applications that use such reactive chemical compounds. Specifically, the present invention relates to methods for reducing degradation of reactive chemical compounds during transport.

2. Description of Related Art

Practices for the safe handling of reactive chemical compounds during manufacture and industrial application are improving as the need for higher purity compounds grows. When handling high purity, reactive chemical compounds it is necessary to inhibit reaction and thus maintain the purity level. Nitrogen trifluoride (NF₃) is an example of a highly reactive chemical compound, specifically a strong oxidizer, which is used in the semiconductor industry.

Various gaseous fluorine-containing compounds are utilized in manufacturing processes that plasma-etch silicon-type materials in order to fabricate semiconductor devices. A major use of NF₃ is as a “chemical vapor deposition” (CVD) chamber cleaning gas in semiconductor device manufacture. CVD chamber cleaning gases are used to form plasmas, which interact with the internal surfaces of semiconductor fabrication equipment to remove the various deposits that accumulate over time.

Perfluorinated chemicals such as NF₃ that are used in semiconductor manufacturing applications are more commonly referred to as “electronic gases”. Electronic gases having ultra high purity are critical for such semiconductor device manufacture applications as very small amounts of impurities entering semiconductor device manufacturing tools can result in wider than desired line width and thus reduce the amount of information that may be contained on a single semiconductor device. Moreover, the presence of these impurities, including but not limited to particulates, metals, moisture, and other halocarbons in the plasma etchant or cleaning gases, even when only present in the part-per-million level, increases the occurrence of defects in the production of these high-density integrated circuits. As a result, there has been increasing demand for ultra high purity etchant and cleaning gases, and an increasing market value for the materials having such ultra high purity.

Methods are needed for transporting such compounds from various locations within the manufacturing process to other locations, such as storage tanks, product containers, and analytical measurement devices. All of these methods must be capable of delivering the reactive compound to the desired location without increasing the impurities contained within the product, or producing new impurities. In the case of transport to an analytical measurement device this is even more critical as the analytical measurement must be made on a sample that is representative of the actual contents of the container that is being sampled. Change of the level of an impurity or formation of new impurities during transport would produce results that misrepresent the actual purity of the reactive compound.

Some impurities may be present in reactive compounds as introduced by the process of manufacture. For NF₃, these impurities include but are not limited to nitrous oxide (N₂O), carbon dioxide (CO₂), dinitrogen difluoride (N₂F₂), and dinitrogen tetrafluoride (N₂F₄). While desirable to reduce the level of all of these impurities in the product for sale, as mentioned previously, it is imperative to an analytical measurement, that the levels of these impurities remain unaltered and no additional impurities are formed prior to the measurement.

Other impurities may be introduced to a compound simply by contact with contaminated surfaces, whether in the manufacturing process or in equipment involved in the transport of the reactive compound. Water and air components, such as O₂ and N₂, can be adsorbed onto a metal surface exposed to atmospheric conditions and be incorporated into the product as it passes over such a surface. Sampling of a container into a second container is difficult to do without introducing some amount of these “atmospheric” contaminants. Due to the sensitivity of the semiconductor manufacturing processes to these contaminants, it is not uncommon to see product specifications for water, O₂, N₂, etc., at very low levels, often sub-part-per-million (ppm) levels. Maintaining the low levels produced in the manufacturing process is critical to successful application of NF₃ in semiconductor manufacture process equipment.

It is well known in the art that the use of electropolished surfaces prevents the presence or hold-up of environmental contaminants, such as water, in transport equipment, e.g., tubing, used to transport a sample from a product container to an analytical measurement device. As bleed of held-up impurities into the compound can occur as the compound flows over the surface of the transport equipment, the level of the impurity in the product cannot be determined accurately. Use of electropolished tubing and other features in this transport equipment or systems have allowed for more accurate measurement of ppm and sub-ppm levels of environmental contaminants in electronic gases and other high purity compounds.

The reactive nature of compounds such as NF₃ presents another challenge in transport of the compound: that of preventing degradation. Formation of N₂F₄ and other reactive fluorine species from NF₃ may occur during transport. Such degradation reduces the purity of the product if it occurs while transporting the compound to storage tanks or product containers. Degradation during transport to an analytical measurement device prevents the accurate measurement of purity of the NF₃.

Further, degradation of NF₃ may occur rapidly and in an explosive manner producing a severe safety risk in manufacture and handling of the reactive compound. It is required that methods of transport of such reactive compounds provide for protection of human life and the environment. Therefore, it is essential that the design of transport equipment be aimed at minimizing the risk of any safety incident. For a different reactive compound, other aspects of transport methods might need consideration in order to optimize such methods for the safe handling of that specific reactive compound.

### BRIEF SUMMARY OF THE INVENTION

A method has been discovered for reducing degradation of a reactive compound during transport of such reactive compound from a first location to a second location comprising electropolishing, prior to transport, at least some of the surface that contacts the reactive compound during transport.

A method has been discovered for reducing degradation of a reactive compound during transport of such reactive compound from a first location to a second location comprising minimizing the internal surface area to volume ratio of any equipment used for transport of the reactive compound.

A method has been discovered for reducing degradation of a reactive compound during transport of such reactive compound from a first location to a second location comprising minimizing or eliminating any dead volume within any equipment used for transport of the reactive compound.

The method of the present invention also utilizes design characteristics for the transport equipment that further reduces degradation of the reactive compound comprising electropolishing, prior to contact, at least some of the surface that contacts the reactive compound during transport, minimizing surface area to volume ratio of the internal surfaces and minimizing or eliminating dead volume.

The methods of the present invention meet a need in the chemical industry for safe methods of transporting reactive compounds that additionally maintain the reactive compound with a minimum level of purity.

### DETAILED DESCRIPTION OF THE INVENTION

The present invention relates to a method for reducing the degradation of reactive compounds during transport of such reactive compounds from a first location to a second location. The method includes the steps of electropolishing at least some of the surfaces contacting such reactive compound, minimizing the surface area to volume ratio of the transport equipment, and minimizing or eliminating any dead volume in the transport equipment. In particular, the present invention relates to a method as described above for reducing degradation of fluorinated reactive gases such as nitrogen trifluoride (NF₃).

By reactive compound is meant any chemical compound, which has the potential to decompose or react to produce unwanted impurities or increase the level of impurities already present in the reactive compound during transport from one location to a second location. The method of the present invention could be applied to any fluorinated reactive gases that would react with a metal surface or oxide layer on the metal surface leading to decomposition. Examples of such fluorinated reactive gases are nitrogen trifluoride (NF₃), tungsten hexafluoride (WF₆), chlorine trifluoride (ClF₃), fluorine (F₂), chlorine monofluoride (ClF), dinitrogen tetrafluoride (or tetrafluorohydrazine, N₂F₄), dinitrogen difluoride (N₂F₂), tetrafluorosilane (SiF₄), fluorine monoxide (OF₂), and boron trifluoride (BF₃).

By degradation is meant any reaction of the reactive compound itself such as decomposition that may occur to produce compounds other than the reactive compound and may be considered impurities in the reactive compound. Degradation of NF₃ may occur by the following reaction:

2NF₃→N₂F₄+F₂.

While not wishing to be bound by theory, it is believed that in the presence of a rough metal surface, the formation of N₂F₄ occurs, most likely due to fluorination of the metal surface by decomposition of NF₃ as shown here:

2NF₃+M→N₂F₄+MF₂.

Degradation of other reactive compounds or fluorinated reactive gases may occur by similar pathways or different means entirely.

The first location of the present invention refers to a location within a manufacturing process, product container, loading facility, etc., from which the reactive compound may be removed with the requirement that the level of purity be maintained. This location may include any location within the manufacturing process equipment (e.g., distillation column or dryer, etc.), a storage tank for the reactive compound, or a product container for the reactive compound.

The second location of the present invention refers to a location, which will be required to receive the reactive compound with the original purity level maintained with as little change as may be desirable. This second location may include a storage tank for the reactive compound, a product container for the reactive compound, or an analytical measurement device. The analytical measurement devices may include on-line devices for monitoring of process materials, portable devices, or stationary laboratory devices for final product analysis against a given product specification, as for generation of a certificate of analysis for a given product container. The analytical measurement devices may include but are not limited to moisture analyzers, gas chromatographs for determination of “inerts” (air components such as N₂ or O₂), or gas chromatographs for determination of other impurities, such as N₂F₂ or N₂F₄ in the case of NF₃.

High quality smooth metal surfaces are required for the internal surfaces of the present invention's transport equipment. The mechanical preparation of metal surfaces for industrial use can be divided into two stages: (a) “roughing down,” using grinding and abrasion techniques to produce a reasonably smooth and macroscopically plane surface, and (b) “polishing,” using fine abrasives or polishing pads to give a smooth and bright surface. Examination of mechanically polished surfaces show that the extreme surface layer is intensely deformed, and that the final smooth surface is produced by a flow process, i.e. metal from the peaks is forced into the hollows. A mechanically polished metal surface yields an abundance of microscopic scratches, strains, metal debris and embedded abrasives.

By electropolishing is meant the treatment of a metal surface whereby the metal is made an anode in an electrolytic cell, and electrolysis is performed to smooth the deformed metal surface that was produced by any initial mechanical preparation and/or polishing. In order to produce the best electropolishing results, the metal should be homogeneous and as free as possible from surface defects. Defects which are normally hidden by mechanical polishing may be revealed, or even exaggerated, by electropolishing, e.g. inclusions, casting irregularities, seams, etc. will be eliminated if they are near the metal surface, but are exaggerated if they lie at a critical distance from the surface. This critical distance is the average depth of metal removed during the electropolishing. Without wishing to be bound by theory, it is believed that smoothing during electropolishing can be accounted for qualitatively by the differences in concentration gradient of a layer that is formed over the metal microscopic peaks and valleys. At the peaks the layer is thin and the concentration gradient is higher while in the valleys the layer is thicker and the concentration gradient is lower. Preferential solution of the peaks occurs and the surface is smoothed.

The electropolished surfaces of the present invention may be made of metals including aluminum, chromium, cobalt, copper, gold, iron, nickel, platinum, silver, tin, titanium, and zinc. The electropolished surfaces may also be made of metal alloys including nickel silver, Monel® (comprising primarily copper and nickel), Hastelloy® (comprising primarily nickel, molybdenum and chromium), Inconel® (comprising primarily nickel, chromium and iron), Kovar® (comprising primarily nickel, iron, and cobalt), low and high carbon steels and stainless steel (comprising primarily iron, chromium and nickel). The preferred metal surface is made of 316 stainless steel.

The degree of surface roughness of electropolished metals may be described by the arithmetic mean roughness, Ra, expressed in microinches (or micrometers, μm). This is the arithmetic mean of all profile deviations (metal trough depths and peak heights) with respect to the mean surface profile. The electropolished metal surfaces of the present invention have a preferred surface roughness Ra of about 20 microinches (0.5 μm) or less; most preferably, Ra is about 10 microinches (0.25 μm) or less.

By minimizing the internal surface area to volume ratio is meant that the design of the equipment used for transport should be such that the internal surface contacting the reactive compound is reduced relative to the internal volume of the transport equipment between the first location and the second location. If the transport equipment is cylindrical in shape, such as tubing or piping, then the internal surface area (SA) of that equipment is defined as:

SA=2πrl

where: r=radius, of the internal surface; and

l=length;

and the internal volume (V) of such tubing or piping is defined as:

V=πr²l.

It then follows that the surface area to volume ratio for cylindrical transport equipment varies only with the radius of such cylindrical equipment and that to minimize surface area to volume ratio, the radius of the transport equipment may be as large as is practical. Practical aspects that may also be considered in the design of transport equipment include minimizing waste of product, minimizing contact time of the reactive compound with the metal surface, and overall equipment dimension which effects both the contact time and the surface area that can degrade the reactive compound.

By dead volume is meant those internal spaces within the transport equipment where impurities may accumulate and become concentrated relative to the bulk composition. Concentration of such impurities, which may be more reactive than the main component, in such dead volume can lead to unsafe conditions and potentially dangerous incidents.

Minimizing or eliminating dead volume is preferable in the design of the transport equipment and can be accomplished partially by minimizing the number of changes in direction of flow of the reactive compound. Sharp angular bends (changes in direction of flow of 90 degrees or more) are undesirable in transport systems of the present invention. Such bends may provide dead volume for potentially dangerous concentration of reactive species and produce increased degradation. The design of the transport equipment should include a minimum number of angular bends. A preferred configuration would use curved bends rather than angular bends, and the change in the direction of flow would be less than about 90 degrees. The most preferable configuration would use only curved bends of less than about 60 degrees.

Fittings and valves used in the transport equipment are preferably designed as to contain zero or low dead volume. Use of such fittings and valves can reduce the possibility of reactive materials being concentrated in locations within the valve interior. Fittings and valves used in the transport equipment of the present invention may preferably have electropolished internal surfaces for contact with the reactive compound.

Multiposition valves may be used such that transport of the reactive compound to multiple locations is possible using the same transport equipment. The ability to transport the product in this manner is consistent with analysis of the product by multiple analytical methods, which is likely necessary for most products.

Heating of the internal surfaces of the transport equipment is not critical to reducing degradation. However, heating of the internal surfaces can be done prior to or during transport of the reactive compound as a means of removing adsorbed impurities or preventing adsorption of impurities. The temperature to which the internal surfaces of the transport equipment may be heated should be carefully chosen depending upon the stability of the reactive compound being transported, in order not to cause degradation by heating.

Heating of the internal surfaces of the transport equipment may be accomplished by any usual manner of heating equipment. Such usual manners of applying heat include encasing the equipment in a heating mantle, wrapping the equipment with insulated heating tape, or applying steam directly to the exterior of the transport equipment. For example, tubing may be jacketed by larger inner diameter tubing, which is filled with water steam.

Pre-treatment of the internal surfaces of the transport equipment may be done, but is not critical to reducing degradation. Pre-treatment may include flowing a gaseous compound or mixture such as 5% fluorine in helium or other gaseous compound through the transport equipment for some period of time prior to the use of the transport equipment to transport the reactive compound. Or alternately, the pretreatment may involve pressurization of the transport equipment with the gaseous compound or mixture for some period of time.

The transport equipment may be purged with the reactive compound or an inert compound, such as helium, when not in use. Such a purge ensures that the surfaces of the transport equipment remain free of impurities during periods of non-use. In order to minimize waste of the reactive product and the potential for safety incidents, purging with an inert compound is preferred.

### EXAMPLE

A vapor phase sample of nitrogen trifluoride (NF₃) was passed through two 5-inch sections of ½ inch tubing at a temperature of 243° C. One section of tubing was made of non-electropolished 316 stainless steel and the other section of tubing was made of electropolished 316 stainless steel with Ra of 15 microinches. For both experiments the tubing was pre-treated with 5% fluorine in helium. The gas composition at the output of the tubing was monitored by a gas-chromatograph-mass-spectrometer. Table 1 shows the concentration of N₂F₂ and N₂F₄ as measured at the output of the tubing for three different contact times. The concentrations are listed as parts per million by volume (ppm).

TABLE 1

| | Concentration (ppm) | | |
|---|---|---|---|
| | 14 sec. | 28 sec. | 41 sec. |
| Non-electropolished | | | |
| N₂F₂ | 0 | 0 | 1 |
| N₂F₄ | 1 | 5 | 35 |
| Electropolished | | | |
| N₂F₂ | 0 | 0 | 0 |
| N₂F₄ | 0 | 0 | 0 |

The data in Table 1 demonstrates the formation of undesirable impurities in NF3 when such NF3 was exposed to the non-electropolished surface during transport.

What is claimed is:

1. A method for reducing degradation of a reactive compound during transport of such reactive compound from a first location to a second location comprising electropolishing, prior to transport, at least some of the surface that contacts the reactive compound during transport.

2. A method for reducing degradation of a reactive compound during transport of such reactive compound from a first location to a second location comprising minimizing the internal surface area to volume ratio of any equipment used for transport of the reactive compound.

3. A method for reducing degradation of a reactive compound during transport of such reactive compound from a first location to a second location comprising minimizing or eliminating any dead volume within any equipment used for transport of the reactive compound.

4. The method of claim 1, 2, or 3, wherein the reactive compound is a fluorinated reactive gas selected from the group consisting of nitrogen trifluoride, tungsten hexafluoride, chlorine trifluoride, fluorine, chlorine monofluoride, dinitrogen tetrafluoride, dinitrogen difluoride, tetrafluorosilane, fluorine monoxide, and boron trifluoride.

5. The method of claim 4 wherein the reactive compound is nitrogen trifluoride.

6. The method of claims 1, 2 or 3 wherein the second location is an analytical measurement device.

7. The method of claims 1 wherein the electropolished metal surface comprises a metal selected from the group consisting of aluminum, chromium, cobalt, copper, gold, iron, nickel, platinum, silver, tin, titanium, and zinc.

8. The method of claim 1, 2 or 3 wherein the electropolished metal surface comprises a metal alloy selected from the group consisting of nickel silver, Monel®, Hastelloy®, Inconel®, Kovar®, low and high carbon steels and stainless steels.

9. The method of claim 1 wherein the electropolished metal surface is made of 316 stainless steel.

10. The method of claim 1 wherein the surface in contact with the reactive compound is heated.

11. The method of claim 1, 2 or 3 wherein the internal surfaces of any equipment used for transport of the reactive compound are pre-treated with a gaseous mixture of fluorine in helium.

12. The method of claim 1 further comprising the step of minimizing the internal surface area to volume ratio of any equipment used for transport of the reactive compound.

13. The method of claim 1 further comprising the step of minimizing or eliminating any dead volume within any equipment used for transport of the reactive compound.

14. The method of claim 12 further comprising minimizing or eliminating any dead volume within any equipment used for transport of the reactive compound.

15. The method of claim 13 further comprising minimizing the internal surface area to volume ratio of any equipment used for transport of the reactive compound.
